(19) United States
(12) Patent Application Publication
(10) Pub. No.: US 2009/0199734 A1
(43) Pub. Date: Aug. 13, 2009

(54) PRINTING PRODUCTION PLAN GENERATION SYSTEM

(76) Inventor: Uri Vered, Petach-Tikva (IL)

Correspondence Address: David A. Novais;Patent Legal Staff, Eastman Kodak Company, 343 State Street, Rochester, NY, 14650-2201, US

(21) Appl. No.: 12/029,485

(22) Filed: Feb. 12, 2008

(51) Int. Cl. B41F 33/00

(52) U.S. Cl. 101/483

(57) ABSTRACT

A system for generating printing production plans (81) includes providing a first printing product specifications and generating a plurality of print production economics sets (62) from the printing product specification. A preferred print production economics set is selected from the print production economics sets and the preferred print production economics set is provided to a printing production plan calculator (46), which calculates a first printing production plan.

### CROSS REFERENCE TO RELATED APPLICATIONS

Reference is made to commonly-assigned copending U.S. patent application Ser. No. 12/025,807, filed Feb. 5, 2008, entitled A METHOD FOR IMAGING FLEXOGRAPHIC PLATES, by Dardikman et al., the disclosure of which is incorporated herein.

### FIELD OF THE INVENTION

This invention relates to the creation of a printing manufacturing plan in response to a minimal set of printing job parameters to yield multiple, detailed, printing manufacturing plan options.

### BACKGROUND OF THE INVENTION

On a daily basis, printing sites struggle with efficient planning and manufacturing of ordered printing jobs. The aspects of job scheduling, planning, and estimation span various disciplines within a printing site. For example, newly ordered printing jobs are entered into the printing site manufacturing system. During this first stage the following aspects are considered:
a) Prices and profits margins;
b) Production duration; and
c) Scheduling and inventory constraints.

As a result, a printing manufacturing plan is created and a time slot is assigned for the printing job execution.

The following printing job engineering aspects are ignored during this first stage:
d) Detailed engineering production plan; and
e) Detailed manufacturing operating data that encompasses all computerized printing machinery aspects.
   These later subjects will be dealt with separately at the pre-press stage by people with different skills set than the aspects related to print manufacturing. The pre-press department operators will reenter some of the parameters into the pre-press computerized machinery that were already entered into the printing manufacturing system. A pre-press engineering plan will be prepared, and the plan will be adjusted to the available machinery on site for the specific printing job.

Management information system (MIS) software (e.g. PSI Logic by EFI) will deal with aspects a), b), and c), taking care of price estimation, production scheduling, and purchasing of required material needed during for the execution of the printing job. Production planning software (e.g. Preps, UpFront by Kodak) will deal with aspects d) and e), in order to generate a detailed manufacturing data. There is a need in the industry for combining the two distinct processes, i.e. the economic as well as the engineering.

A complete enterprise resource planning (ERP) system for the printing industry dealing with a plethora of distinct modules such as job quoting, ordering, planning, purchasing, inventory management, scheduling and financial management will also include automatic engineering and extremely detailed manufacturing plan creation means. Compared to other industries such as tool manufacturing, it would be desirable to integrate into a single ERP system, economical and engineering aspects of tools manufacturing. This requires automatic creation of engineering and geometric details to feed software programs used in tools manufacturing industry, such as AutoCAD, Simatron, Katia, and Solid Works.

The production planner today, while working on the details of the manufacturing plan needs to consider multiple options for manufacturing. Such considerations include the price, scheduling ramifications, and changing the plan. The only way to currently solve this is by re-entering all this information to a different estimating and scheduling software. Combining the described aspects in a seamless process will solve inherent problems that stem from the current process of separating the economical and engineering realms.

### SUMMARY OF THE INVENTION

Briefly, according to one aspect of the present invention a system for generating printing production plans includes providing a first printing product specifications and generating a plurality of print production economics sets from said printing product specification. A preferred print production economics set is selected from the print production economics sets and the preferred print production economics set is provided to a printing production plan calculator, which calculates a first printing production plan.

With the proposed invention the production planner will be able to see the cost, price, and profit margin of each detailed manufacturing plan; and check, in parallel, inventory and scheduling constraints. This information will be apparent at all times and thus will yield a more effective decision process, with respect to the printing manufacturing process.

The invention will be able to cope efficiently with changes in both economical and engineering aspects. The changes made by the production planner for example will automatically take into effect, both the MIS system and production planning system, and vice versa. For example, if the planner selects a different stock size, the system will generate a new purchase order for a new stock.

### BRIEF DESCRIPTION OF THE DRAWINGS

FIG. 1 is a chart showing different imposition options to produce same job;

FIG. 2 is a schematic illustrating a workflow of accepting a printing job from a sales quote to the generation of a complete production plan;

FIG. 3 is a schematic illustrating printing job estimation tree;

FIG. 4 is a flowchart illustrating printing site decision process in respect of printing equipment and media selection;

FIG. 5 is a schematic of a detailed imposition scheme;

FIG. 6 is an application screen showing different scenarios that can be presented per a single production element;

FIG. 7 is a schematic presenting various folding options; and

FIG. 8 is a schematic showing a production plan in a job definition format (JDF) form.

### DETAILED DESCRIPTION OF THE INVENTION

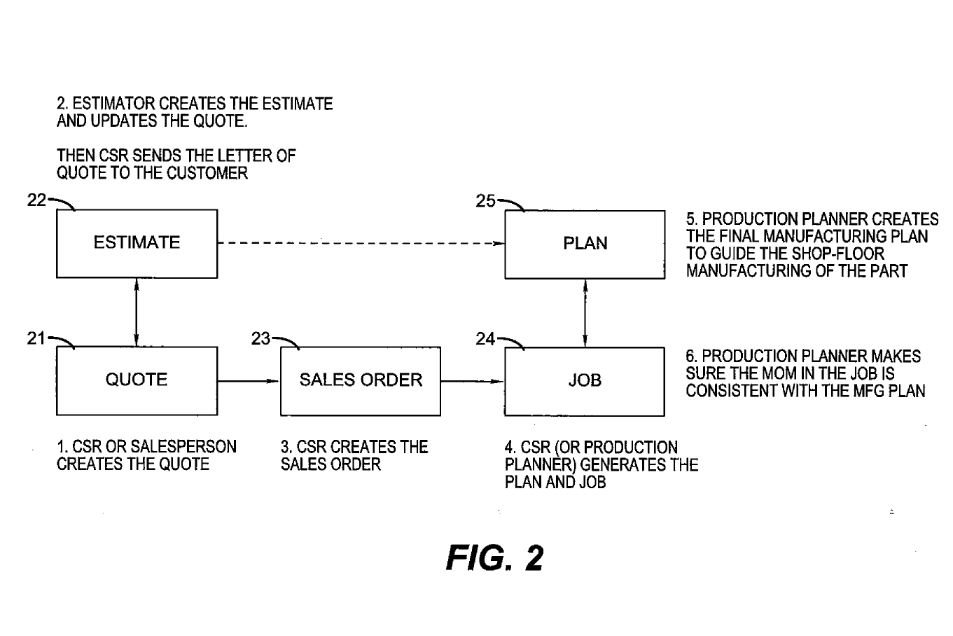

FIG. 2 describes in high level terms the work flow, from the stage of job price assessment to the detailed manufacturing plan on the printing shop floor. The customer service representative (CSR) creates a quote 21 using the opportunity/quote entry program, entering the customer details and information about the quote lines. From within the opportunity/quote entry program, the CSR creates an estimate linked to the quote. (Alternatively, the estimator can create the estimate directly from the estimate entry program).

The estimator uses the estimate entry program 22 to expand the quote line into a detailed manufacturing plan, thereby estimating the cost of manufacturing the part. The system also marks up the cost to propose a price. The estimator returns the estimated cost and price to the quote 21.

The CSR informs the customer of the part's intended price, and if appropriate, creates a sales order 23 derived from the quote 21. The production planner will review the job manufacturing plan 24 previously created in the estimate stage 22. Modifications will be made to the manufacturing plan in order to make it fit to the way the product will be manufactured.

At the last stage, the production planner makes sure that any needed updates to the plan 25 are accurately reflected in the job. Materials, operations and resources required to manufacture the part are identified.

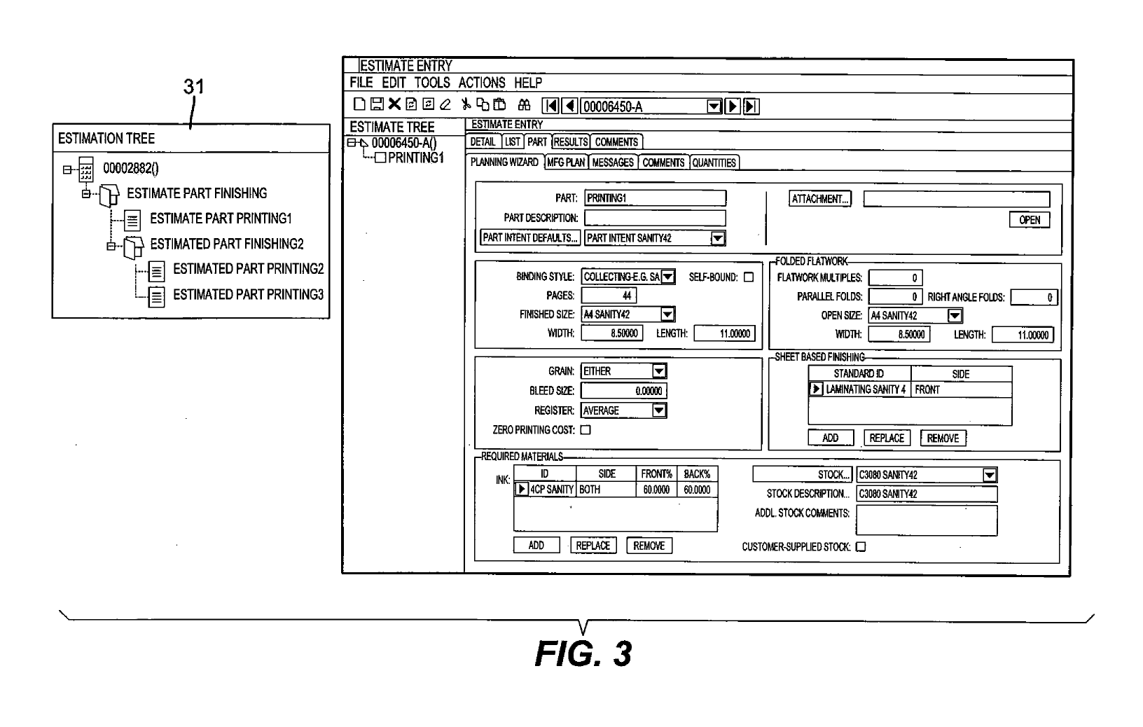

The estimate process will use a multi-level product tree 31 as shown in FIG. 3. Scheduling a finishing part production can only occur when all of the dependent parts have been successfully manufactured, and are available for further use. A finishing part need details from its dependent parts (printing parts and other finishing parts) in order to correctly estimate requirements. For example it is essential for the manufacturing of a finishing part to know the exact weight and number of signatures of each printing part. Similarly, a printing part needs the details of its parent finishing part, for example the number of runs needed for printing of each finishing part.

In another example, a customer requires 5,000 copies of a hardback cover book containing two printing parts: a black and white part of 500 pages and a color part of 20 pages. In this case, the product would be split as follows: the book is the overall priced part, and is therefore the root of the tree hierarchy. Under the book, several estimate parts are defined: the hardback cover is a finishing part, and under that, two subordinate printing parts would be defined, one for the color run and one for black and white. If the book cover has a 5% spoilage rate, the system must calculate producing 5% more of both subordinate printing parts to cover the spoilage of the parent finishing node. In addition, the finishing part needs information from the subordinates about how many signatures are required to help estimate the binding calculations. Sales personnel and customer service representatives can then fill out a product-intent form to capture customer data and the characteristics of the desired product, including imposition parameters, paper size, inks, paper type, and more.

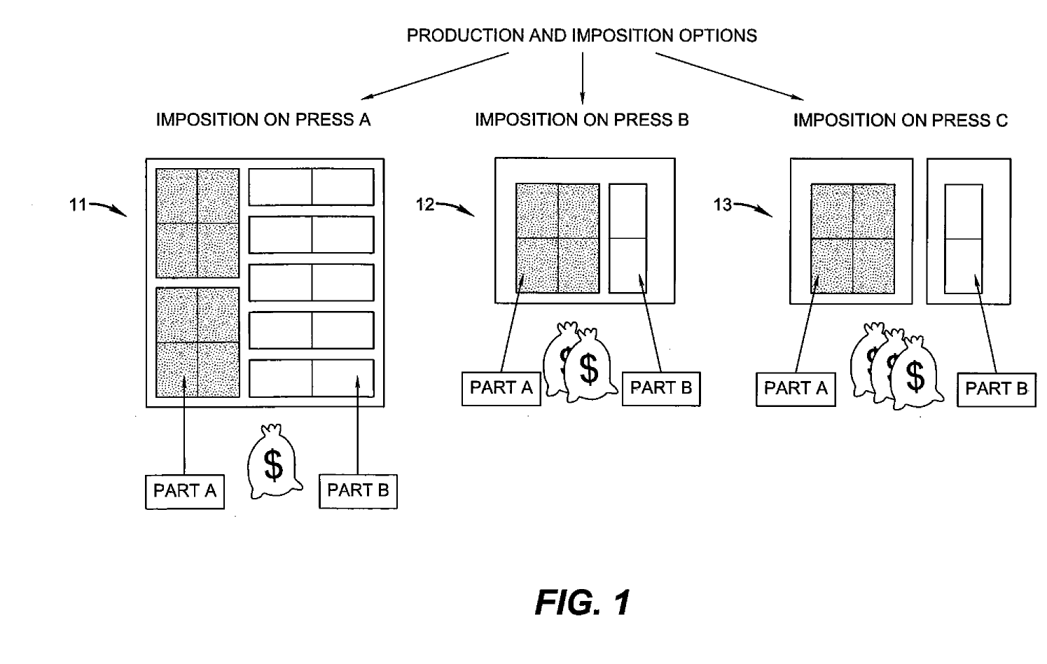

During the planning stage, an imposition algorithm calculates the imposition scheme that maximizes the utilization of the printed sheet and minimizes run time and costs. The imposition algorithm is a computational process that converts the description of a printing part into a series of well-defined layout groups and layouts. It calculates the most efficient method or printing the part, by arranging the maximum number of pages on the largest sheet available for a given press. The imposition algorithm makes the print job more efficient taking into considerations the following aspects:
1. Shorten the run length of the job; and
2. Minimize the:
   a) Stock amount
   b) Number of plates
   c) Press setup time
      Several imposition schemes can be created for a specific job, depending on the characteristics of the various available printing presses on site. Presses capable of printing four pages on a sheet, or eight pages, will employ different imposition schemes as is depicted in FIG. 1. Several imposition options 11, 12, and 13 were prepared to comply with the various presses on site.

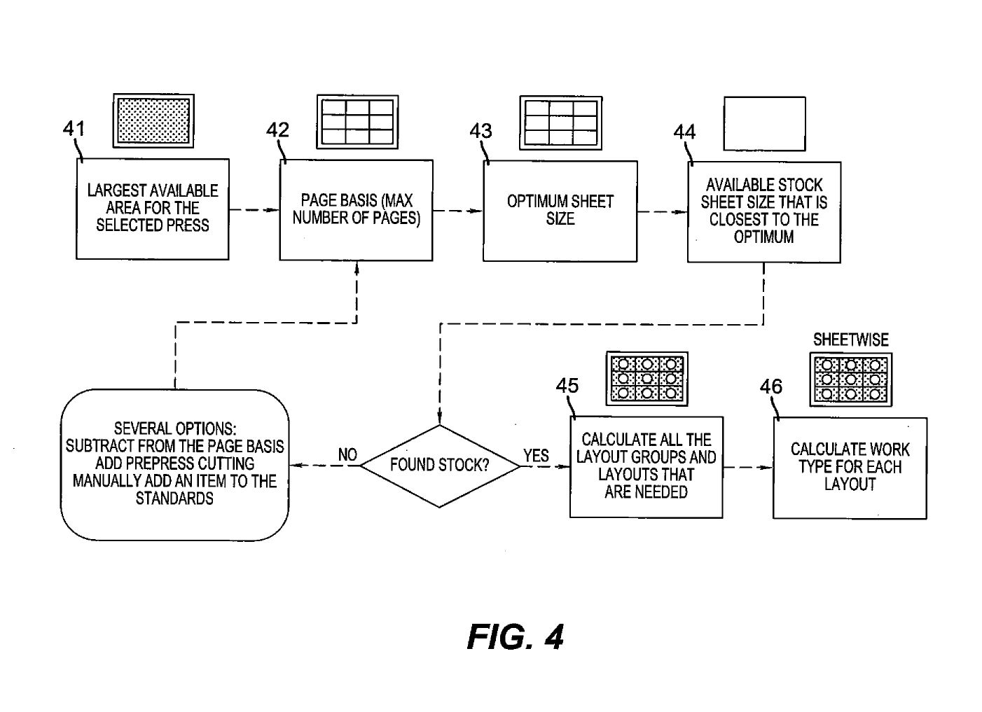

Reference is made to FIG. 4 in order to best explain the imposition algorithm calculation stages. The factors that should be considered to achieve the best imposition plan are listed below:
1. The maximum area available 41 for printing with a specific press excluding color bars, grippers, etc.;
2. The page basis 42 is calculated as, the maximum number of pages that can be squeezed into this area;
3. The optimum sheet size 43 for a specific job is the smallest sheet that accommodate the maximum number of pages in the sheet area, and produce the least waste out of sheet space;
4. The sheet size that is closest to optimum size 44, from the available stock. It must be equal to or larger than the optimum size;
5. In case the right sheet size cannot be found, the page basis 42 should be reduced and the process should be repeated;
6. In the case that the proper sheet size still cannot be found, one of the options to overcome this will be, having pre-press cut the existing sheets in order to create the appropriate sheet size; otherwise, in the case that a proper sheet size is found, then the layout options 45 are calculated conforming with the proper sheet size;
7. Place the maximum number of pages into the layout format 46; and
8. Any remaining pages that are less than the page basis are fit into the layout in multiples.

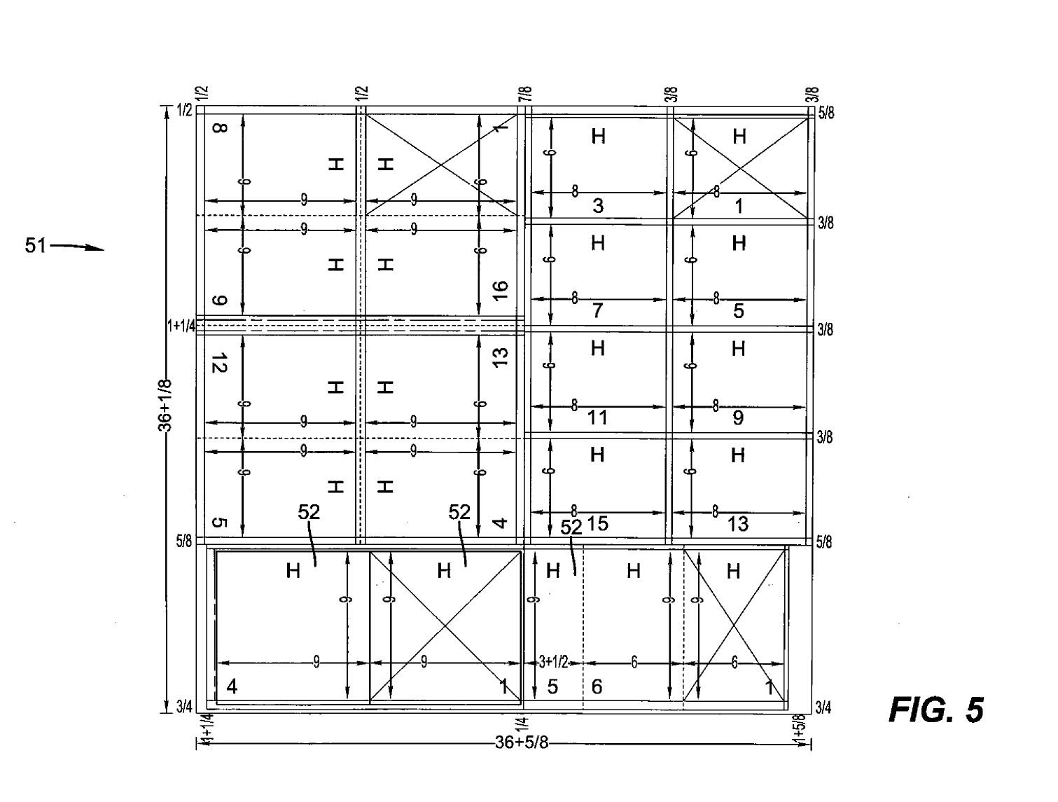

FIG. 5 describes a detailed diagram imposition scheme 51 calculated and created as a result of the entered product intent information. This is very detailed geometrical engineering type drawing that describes how each part 52 should be manufactured.

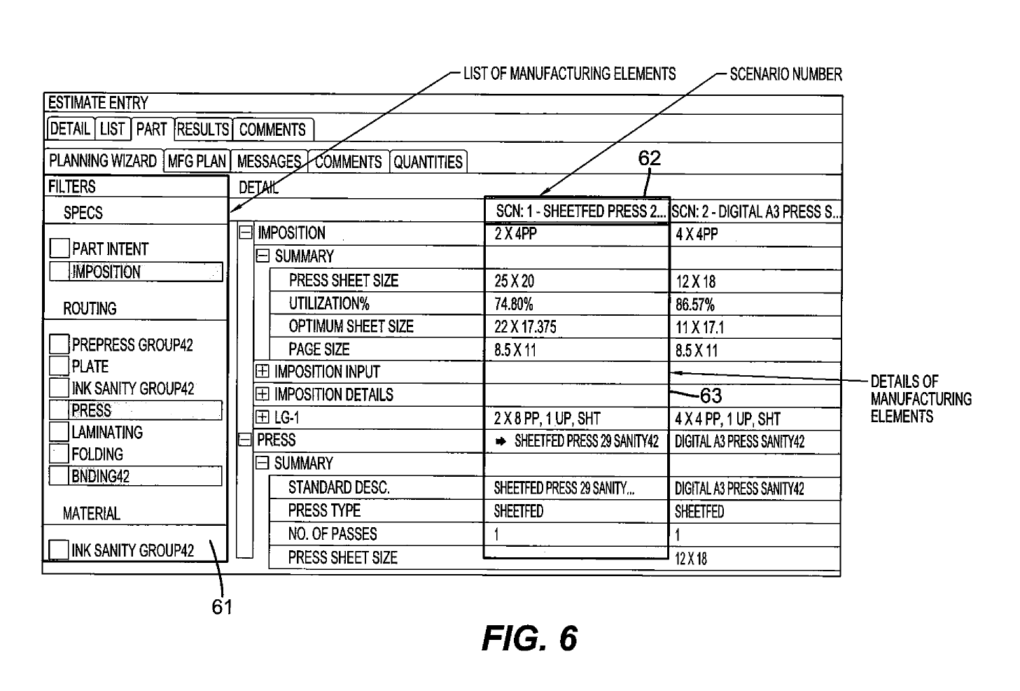

FIG. 6 shows a list of manufacturing elements 61. Each element different scenario 62 can be presented and compared to help in choosing the most suitable scenario. For each scenario details of manufacturing elements 63 are available. In order to secure the most cost-effective scenario for example, detailed information of material cost and inventory constraints will be considered.

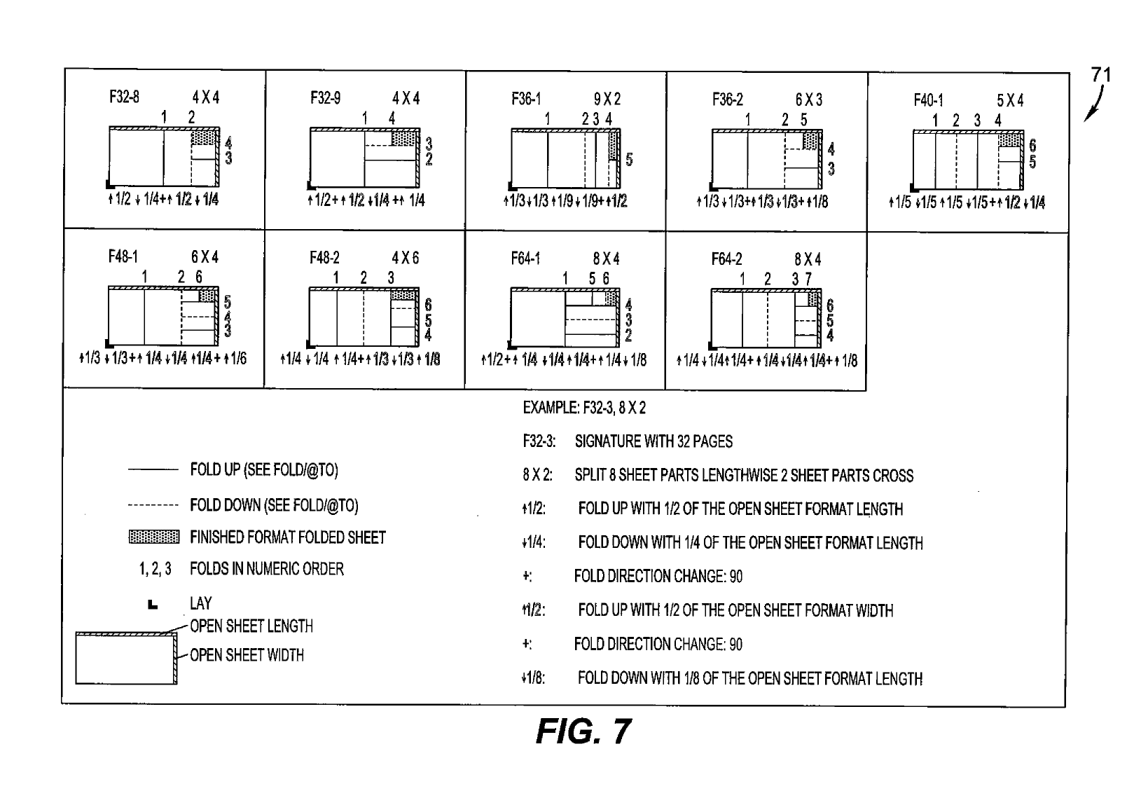

Another important stage is the folding stage. Referring to FIG. 7, the motivation here is to allow the user to predetermine the folding patterns and sequence for different folding sections.

A job definition format (JDF) can be used in order to describe the full printing job plan. JDF is an established international standard and is produced and used by a plethora of print related applications, describing various stages in a printing job process. A JDF fold tag is selected from a JDF fold catalog is used to indicate the folding instructions 71 as basis for this feature. The JDF includes detailed folding specifications, it may include general stripping parameters as well to describe printing job imposition scheme for example.

This folding feature allows the user to view a table called a fold tag from the JDF catalog. This user, which is often a planner in this case, will mark as inactive folding sequences that are not to be selected by other users in the system. The user will define the fold tag preference and assign a fold tag per each set of rules. This is basically a setup table that will define for each arrangement of pages, such as default fold tag in addition to min/max caliper.

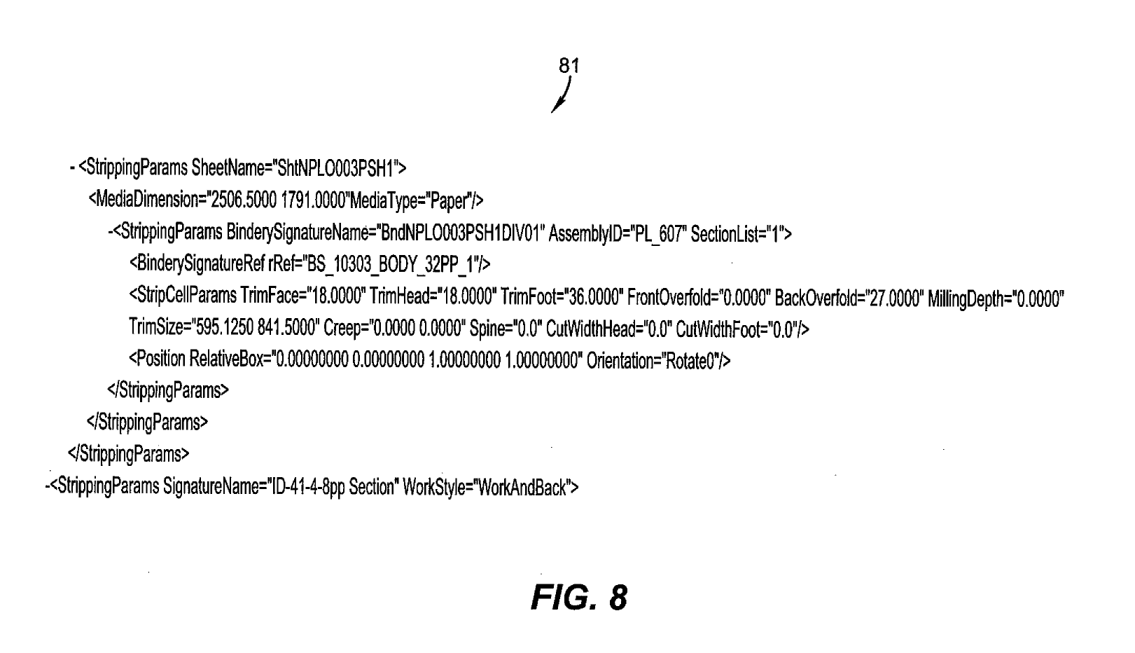

In the estimation application an algorithm to analyzes the data from the fold tag preference table and the estimate will be used to automate the selection of fold tag and deterring the fold sequence. JDF will be automatically be created to include all relevant product and manufacturing details. As indicated above, the JDF is an international printing standard format that allows most of the computerized systems and machinery to share data and control, and to communicate with each other. A JDF representation will be created and an example of a JDF sequence 81 is depicted in FIG. 8. An exact manufacturing instruction in a JDF form is created for all the machinery that will take place in the printing process.

Kodak Prinergy is a well known digital front end, used at numerous printing sites geared for “digital plates” preparation. In essence a digital plate is data ready to be handed over to a plate imaging device for exposure. For example, sites equipped with Prinergy will include Prinergy job information embedded in the JDF, along with additional information and manufacturing specification to comply with other printing equipment available in the printing site. This example illustrates efficient handling and operating of the machinery required to manufacture specific printing job.

The first part of the invention relates to creation of production details and geometric diagrams according to minimal set of parameters. There will an automatic creation of geometric diagrams to be used as the base for exact positioning of data on the printing plate and the press sheet. The level of details that is created is achieved by other production planning software today only by manual entry of multiple parameters by the user. Many of the parameters can not be validated as they are not connected to the ERP list of materials and machinery.

After the user enters a minimal set of product parameters multiple high level production options are created, to include a printing plan associated with cost, prices, time, and material quantities for each specific production element. Once the user viewed and possibly edited the high level manufacturing plan, automatic creation of JDF with all relevant product and manufacturing details will take place.

At this stage, the detailed manufacturing plan maybe altered by the user both in respect to production economics (ERP) aspects, or engineering aspects. Each change in the detailed manufacturing plan will trigger an automatic plan update to be reflected in production economics and engineering aspects of the printing plan. Changes will affect subjects such as materials, operations, purchasing, and scheduling.

The invention has been described in detail with particular reference to certain preferred embodiments thereof, but it will be understood that variations and modifications can be effected within the scope of the invention.

### PARTS LIST

11 imposition option 1
12 imposition option 2
13 imposition option 3
21 quote
22 estimate
23 sales order
24 job manufacturing plan
25 job plan
31 estimation tree
41 largest available area
42 page basis
43 optimum sheet size
44 available stock sheet
45 layout options
46 calculate work type per layout
51 imposition scheme
52 manufacturing part
61 manufacturing elements
62 different resulted scenarios
63 details of manufacturing elements
71 folding options
81 production plan in JDF form

1. A system for generating printing production plans comprising:
a) providing a first printing product specifications;
b) generating a plurality of print production economics sets from said printing product specification;
c) selecting a preferred print production economics set from said print production economics sets;
d) providing said preferred print production economics set to a printing production plan calculator; and
e) calculating a first printing production plan.

2. The system of claim 1 wherein said production plan includes production economics aspects and print engineering aspects.

3. The system of claim 1 comprising:
f) providing a second printing product specification; and
g) repeating steps b) through e) to produce a second printing production plan.

4. The system of claim 1 wherein a change in said production economics aspects is reflected in said print engineering aspects.

5. The system of claim 1 wherein a change in said print engineering aspects is reflected in said production economics aspects.

6. The system of claim 1 wherein said first printing product specifications consists of at least the following parameters, paper stock, ink colors, page information, lamination requirements, binding options, or combinations thereof.

7. The system of claim 1 wherein said production economics aspects consist of cost, price, profit margins, value added margins, scheduling and inventory constraints, or combinations thereof.

8. The system of claim 1 wherein said print engineering aspects consist of:
dimension of required materials;
specific productions instruction such as folding plan, required print methods, colors, and binding methods; and
exact imposition off all pages across all multiples of printed layouts, or combinations thereof.

9. The system of claim 1 wherein selection of said preferred print production or economics is based on a price comparison.
